(19) United States
(12) Patent Application Publication
(10) Pub. No.: US 2016/0370134 A1
(43) Pub. Date: Dec. 22, 2016

(54) HEAT EXCHANGER PLATE FOR TRANSITION LIQUID PHASE BONDING

(71) Applicant: DOOSAN HEAVY INDUSTRIES & CONSTRUCTION CO., LTD., Gyeongsangnam-do (KR)

(72) Inventors: Jeong Kil KIM, Busan (KR); Yong Jai KIM, Gyeongsangnam-do (KR); Deog Nam SHIM, Gyeongsangnam-do (KR); In Chul JUNG, Gyeongsangnam-do (KR)

(21) Appl. No.: 15/172,830

(22) Filed: Jun. 3, 2016

(30) Foreign Application Priority Data
Jun. 22, 2015 (KR) 10-2015-0088263

(51) Int. Cl. F28F 21/08; F28F 3/00; B23P 15/26

(52) U.S. Cl. CPC F28F 21/087; B23P 15/26; F28F 3/00; F28F 21/084

(57) ABSTRACT

A heat exchanger includes a plurality of plates bonded by transition liquid phase (TLP) bonding. Since the plates are bonded by the transition liquid phase bonding a good bonding portion may be formed reducing defects therein, thereby enabling the heat exchanger to have a high quality. In addition, since the bonding process is performed under a mild condition, it is possible to easily employ a bonding condition and more improve production efficiency.

### CROSS-REFERENCE(S) TO RELATED APPLICATIONS

This application claims priority to Korean Patent Application No. 10-2015-0088263, filed on Jun. 22, 2015, the disclosure of which is incorporated herein by reference in its entirety.

### BACKGROUND

Exemplary embodiments of the present disclosure relate to a heat exchanger plate designed to bond a plurality of plates, constituting a heat exchanger, by transition liquid phase (TLP) bonding, a heat exchanger including a plate laminate made by bonding the plates with TLP bonding, and a method of manufacturing the same.

In general, a refrigeration system such as a refrigerator or an air conditioner includes a compressor which compresses a gas refrigerant, a condenser which exchanges heat between the refrigerant compressed by the compressor and outside air to condense the refrigerant by releasing the heat to the outside, an expansion mechanism which expands the refrigerant condensed by the condenser, and an evaporator which evaporates the refrigerant expanded by the expansion mechanism by absorbing heat from air in a space to be cooled or for air cooling.

Each of the evaporator and the condenser is a heat exchanger which exchanges heat between refrigerant and ambient air. The heat exchanger may be a fin-type heat exchanger configured by a refrigerant pipe, through which a refrigerant passes, and a plurality of fins arranged to be spaced apart from each other while penetrating the refrigerant pipe, or a plate-type heat exchanger configured by a plurality of plates and a refrigerant pipe attached to one surface of each plate.

Conventionally, solid phase bonding or brazing is widely used to bond the plates in the plate-type heat exchanger.

However, in order to use the solid phase bonding, it is necessary to strictly manage the surface roughness of each plate and to perform a pressing process under the conditions of a high degree of vacuum equal to or greater than about 10⁻⁴ torr and a high pressure equal to or greater than about 3 to 7 MPa. For this reason, it is very difficult to actually perform the solid phase bonding.

In addition, the brazing is performed by inserting a filler metal between the plates and bonding them in a vacuum furnace or a hydrogen furnace. However, the brazing may lead to poor bonding since bubbles are generated or precipitates are formed while an organic binder contained in the liquid-phase filler metal is dissolved and volatilized.

Accordingly, there is a need for a bonding methods to bond plates at high efficiency by simple and easy processes.

### BRIEF SUMMARY

An object of the present disclosure is to provide a heat exchanger plate designed to be bonded by transition liquid phase bonding.

Another object of the present disclosure is to provide a heat exchanger in which a plurality of plates are simply and easily bonded at low cost by transition liquid phase bonding using a heat exchanger plate, and the bonding portion formed thereby has a high quality.

Other objects and advantages of the present disclosure can be understood by the following description, and become apparent with reference to the embodiments of the present invention. Also, it is obvious to those skilled in the art to which the present disclosure pertains that the objects and advantages of the present disclosure can be realized by the apparatus and methods claimed and combinations thereof.

In accordance with one aspect of the present disclosure, a heat exchanger plate includes a plate, and an alloy layer bonded to a bonding object by transition liquid phase bonding on at least one surface of the plate, wherein the alloy layer includes at least one of melting point depression elements such as B, Si, and P.

A passage in which a liquid or gas phase fluid flows may be formed in the at least one surface of the plate.

The plate may be one of an STS plate, a Ni-alloy plate, and an Al-alloy plate.

The alloy layer may have a thickness of 30 to 100 μm.

The alloy layer may include 5 to 25% by weight of Cr, more than 0 to 10% by weight of Si, more than 0 to 5% by weight of Al, more than 0 to 5% by weight of Ti, 0.5 to 4% by weight of B, and a balance of Ni.

The alloy layer may include 1 to 5% by weight of B and 95 to 99% by weight of Ni.

The alloy layer may include 1 to 13% by weight of P and 87 to 99% by weight of Ni.

The alloy layer may include more than 0 to 15% by weight of Si, more than 0 to 2% by weight of Mg, and a balance of Al.

The alloy layer may be formed by electroless plating or thermal spray coating.

In accordance with another aspect of the present disclosure, a heat exchanger includes two or more of an STS plate, a Ni-alloy plate, and an Al-alloy plate, and an alloy layer bonded to a bonding object by transition liquid phase bonding on at least one surface of each of the plates, a passage in which a liquid or gas phase fluid flows being formed in the at least one surface of the plate, the alloy layer including at least one of melting point depression elements such as B, Si, and P, the alloy layer being formed by electroless plating or thermal spray coating, wherein the two or more plates are laminated in a state in which the alloy layer is interposed between the respective plates, and the alloy layer forms a bonding portion by the transition liquid phase bonding.

The alloy layer may include 5 to 25% by weight of Cr, more than 0 to 10% by weight of Si, more than 0 to 5% by weight of Al, more than 0 to 5% by weight of Ti, 0.5 to 4% by weight of B, and a balance of Ni.

The alloy layer may include 1 to 5% by weight of B and 95 to 99% by weight of Ni.

The alloy layer may include 1 to 13% by weight of P and 87 to 99% by weight of Ni.

The alloy layer may include more than 0 to 15% by weight of Si, more than 0 to 2% by weight of Mg, and a balance of Al.

In accordance with a further aspect of the present disclosure, a method of manufacturing a heat exchanger includes preparing two or more plates, forming an alloy layer including at least one of melting point depression elements such as B, Si, and P such that the alloy layer is bonded to a second plate by transition liquid phase bonding on at least one surface of each of the plates, laminating the two or more plates, each having the alloy layer formed thereon, and performing bonding heat treatment by heating and maintaining the laminated plates under conditions of a degree of vacuum of 1×10⁻⁴ to 1×10⁻³ torr and a temperature of 900 to 1200° C. for 0.1 to 6 hours.

The forming an alloy layer may be performed by electroless plating or thermal spray coating.

The forming an alloy layer may be performed such that the alloy layer has a thickness of 30 to 100 μm.

The method may further include, after forming the alloy layer by the electroless plating or thermal spray coating, forming a passage, in which a liquid or gas phase fluid flows, in each of the plates.

The method may further include, before forming the alloy layer by the thermal spray coating, forming a passage, in which a liquid or gas phase fluid flows, in each of the plates.

In the laminating the two or more plates, the two or more plates may be laminated such that the alloy layer is interposed between the respective plates.

The “second plate” used herein means any plate, which is formed or not formed with an alloy layer, for transition liquid phase bonding according to the present invention, and may have a material equal to or different from the plate, as the bonding object, having the alloy layer.

It is to be understood that both the foregoing general description and the following detailed description of the present disclosure are exemplary and explanatory and are intended to provide further explanation of the invention(s) as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a cross-sectional view illustrating a heat exchanger plate according to an embodiment of the present disclosure;

FIG. 1B is a cross-sectional view illustrating a heat exchanger plate according to an embodiment of the present disclosure;

FIG. 2 is a view schematically illustrating a plasma gun used when an alloy layer is formed on a plate by thermal spray coating according to an embodiment of the present disclosure;

FIG. 3 is a flowchart schematically illustrating a process of manufacturing a heat exchanger plate according to an embodiment of the present disclosure;

FIG. 4 is a flowchart schematically illustrating a process of manufacturing a heat exchanger plate according to an embodiment of the present invention;

FIG. 5 is a cross-sectional photograph illustrating a bonding portion when plates are bonded by transition liquid phase bonding using a heat exchanger plate according to an embodiment of the present disclosure (Example 1) in Experimental Example 1;

FIG. 6 is a cross-sectional photograph illustrating a bonding portion when plates are bonded by brazing (Comparative Example 1) in Experimental Example 1;

FIG. 7 is a cross-sectional photograph illustrating a bonding portion when plates are bonded by transition liquid phase bonding using a heat exchanger plate according to an embodiment of the present disclosure (Example 2) in Experimental Example 2;

FIG. 8 is a cross-sectional photograph illustrating a bonding portion before post heat treatment when plates are bonded by solid phase bonding (Comparative Example 2) in Experimental Example 2; and

FIG. 9 is a cross-sectional photograph illustrating a bonding portion after post heat treatment when plates are bonded by solid phase bonding (Comparative Example 2) in Experimental Example 2.

### DETAILED DESCRIPTION

Exemplary embodiments of the present disclosure will be described below in more detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Throughout the disclosure, like reference numerals refer to like parts throughout the various figures and embodiments of the present disclosure.

The present inventors discovered that, when a heat exchanger including a plurality of plates is manufactured, it is possible to improve the quality of a bonding portion and simply and easily perform a bonding process under a mild condition compared to conventional solid phase bonding since defects do not occur in the bonding portion when the plates are bonded by transition liquid phase (TLP) bonding.

Specifically, a heat exchanger plate according to an embodiment of the present disclosure includes a plate, and an alloy layer which may be bonded to a bonding object by transition liquid phase bonding on at least one surface of the plate. The alloy layer includes at least one of melting point depression elements such as B, Si, and P.

In the present disclosure, the bonding object refers to another object which may be bonded with the plate. For example, the bonding object may be a second plate which is formed or not formed with an alloy layer, or may be other components such as a refrigerant pipe included in a heat exchanger, but the present disclosure is not limited thereto.

In the present disclosure, the alloy layer may be formed by electroless plating or thermal spray coating.

Here, at least one surface of the plate according to the present disclousre may be formed with a passage in which heat exchange may be performed while a liquid or gas phase fluid flows in the passage. In this case, the alloy layer of the present disclosure may be formed on a surface in which the passage is formed, or may be formed on a different surface in which the passage is not formed. Here, when the alloy layer is formed on the surface in which the passage is formed, the alloy layer is formed only in a portion except for the passage.

In addition, the shape of the passage is not especially limited in the present disclosure. For example, the passage may have a zigzag shape that obtains a sufficient passage length in order to enhance heat exchange efficiency.

When plates are bonded by conventional brazing, the filler metal between the plates is typically used in the form of powder. In this case, if the powder-type filler metal is not accurately applied to the bonding portion of the plates, a passage may be clogged with the filler metal.

However, the passage on the plate may not be clogged in the present disclosure since the alloy layer formed by electroless plating or thermal spray coating for transition liquid phase bonding is uniformly formed along the surface of the plate which is not formed with the passage. In addition, since the bonding is performed only in a portion in which the passage is not formed, a bonding quality can be further enhanced.

In addition, the thickness of the alloy layer is not especially limited in the present disclosure. For example, it is preferable that the alloy layer has a thickness of 30 to 100 μm. When the alloy layer has a thickness less than 30 μm, it may be mroe difficult to form a bonding portion. When the alloy layer has a thickness greater than 100 μm, the alloy layer may not be sufficiently spread to a base material during transition liquid phase bonding and it may be problematic in terms of economy.

In the present disclosure, the composition of the alloy layer includes at least one of elements such as B, Si, and P which may depress the melting point of the plate base material, and may further include Cr and/or Ni as occasional demands in order to improve corrosion resistance and oxidation resistance. However, the present disclosure is not limited thereto.

In addition, the specific composition of the alloy layer may be properly adjusted according to materials of the plate in the present disclosure. When the plate is made of an STS material or a nickel alloy, the alloy layer may preferably include 5 to 25% by weight of Cr, more than 0 to 10% by weight of Si, more than 0 to 5% by weight of Al, more than 0 to 5% by weight of Ti, 0.5 to 4% by weight of B, and a balance of Ni. More preferably, the alloy layer may include 5 to 20% by weight of Cr, more than 0 to 5% by weight of Si, more than 0 to 5% by weight of Al, more than 0 to 5% by weight of Ti, 0.5 to 4% by weight of B, and a balance of Ni. In another example, the alloy layer may include 1 to 5% by weight of B and 95 to 99% by weight of Ni. In a further example, the alloy layer may include 1 to 13% by weight of P and 87 to 99% by weight of Ni, and more preferably may include 1 to 10% by weight of P and 90 to 99% by weight of Ni.

Here, the specific composition of the STS plate is not especially limited. For example, STS 316L or STS 304 may be used as the material of the plate.

The specific composition of the nickel-alloy plate is not especially limited. For example, an inconel 617 plate or a hayness 230 plate may be used as the plate.

When the plate is made of an aluminum alloy, the alloy layer may preferably include more than 0 to 15% by weight of Si, more than 0 to 2% by weight of Mg, and a balance of Al.

Meanwhile, the thickness of the plate used in the present invention is not especially limited, and it may be selected according to devices to which a heat exchanger is applied or components thereof. However, the plate preferably has a thickness of 0.05 to 0.15 mm in consideration of heat exchanger efficiency and economy.

FIG. 1A is a cross-sectional view illustrating a heat exchanger plate according to an embodiment of the present disclosure. Refrigerant passages 10 having a hemispherical cross-sectional shape are formed on one surface of a plate 1, and an alloy layer 100 for transition liquid phase bonding is formed along a portion in which the passages 10 are not formed on the surface of the plate 1.

FIG. 1B is a cross-sectional view illustrating a heat exchanger plate according to another embodiment of the present disclosure. Refrigerant passages 10 having a hemispherical cross-sectional shape are formed on one surface of a plate 1, and an alloy layer 100 for transition liquid phase bonding is formed along a surface different from the surface on which the passages 10 are formed.

In an embodiment, the present disclosure provides a method of manufacturing a heat exchanger plate including a step of preparing a plate, and a step of forming an alloy layer including at least one of melting point depression elements such as B, Si, and P such that the alloy layer may be boned to a bonding object by transition liquid phase bonding on at least one surface of the plate.

In the present disclosure, the bonding object refers to another object which may be bonded with the plate. For example, the bonding object may be a second plate which is formed or not formed with an alloy layer, or may be other components such as a refrigerant pipe included in a heat exchanger, but the present discclosure is not limited thereto.

The step of forming an alloy layer is performed by electroless plating or thermal spray coating.

Specifically, the electroless plating may be performed by depositing at least one surface of the plate into a plating solution which includes an alloy composition having at least one melting point depression element of B and P, and a reducing agent.

Here, the type of the reducing agent is not especially limited. For example, the reducing agent may be at least one selected from the group consisting of formaldehyde (HCHO), glyoxylic acid made based on glycerin, sodium hypophosphite (NaPO₂H₂.H₂O), boron hydride, and dimethylamine-boron (DMAB).

In addition, the thermal spray coating may be performed by spraying an alloy composition having at least one melting point depression element of B and P onto at least one surface of the plate using a plasma gun or the like.

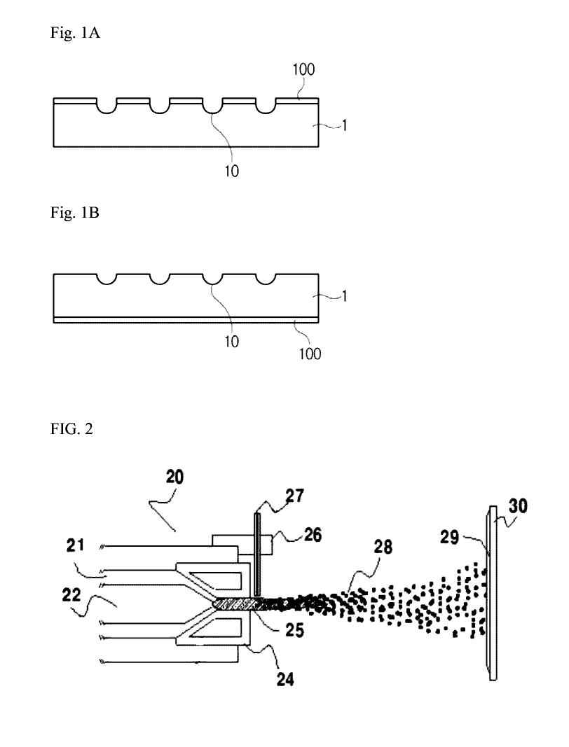

In more detail, FIG. 2 is a view schematically illustrating a plasma gun 20 used for thermal spray coating. When plasma gas (e.g. Ar, N₂, H₂, or He) is introduced into the plasma gun 20 through a gas inlet 21, the gas is partially dissociated while passing through a gap between a cathode 22 and an anode 24 to which high-voltage DC power (typically, 30 to 100 KV, 400 to 1000 A) is applied, to thereby form a plasma flame 25 having a high temperature of 5,000 to 15,000° C., and an alloy composition made in the form of powder or wire is injected into the high-temperature plasma flame 25 through a powder inlet 27. The powder inlet 27 is fixed to the plasma gun by a support 26, and the powder-type alloy composition 28 injected through the powder inlet 27 flies toward a coating object, i.e. a plate 30 at high speed (200 to 700 m/s) in the state in which it is fully or partially melted by the high-temperature plasma flame, thereby forming an alloy layer 29.

Meanwhile, at least one surface of the plate may be formed with a passage in which heat exchange may be performed while a liquid or gas phase fluid used as refrigerant flows in the passage. The process of forming the passage is not especially limited, and may be performed by typical methods known to those skilled in the art. For example, various passages may be formed on the plate by machining or chemical etching.

The process of forming the passage may be performed before or after the step of forming an alloy layer, but the present disclosure is not limited thereto.

However, when the alloy layer is formed on the surface of the plate in which the passage is formed in an embodiment, it is preferable that the passage is formed after forming the alloy layer by electroless plating or thermal spray coating, or after the passage is formed, the alloy layer is formed by thermal spray coating only in a portion in which the passage is not formed.

In addition, when the alloy layer is formed on the surface of the plate in which the passage is not formed in another embodiment, the process of forming the passage may be selectively performed before or after the step of forming an alloy layer according to conditions for performing the process.

The step of forming an alloy layer in the present invention is preferably performed such that the alloy layer has a thickness of 30 to 100 μm. When the alloy layer has a thickness less than 30 μm, it may be difficult to sufficiently form a bonding portion. When the alloy layer has a thickness greater than 100 μm, the alloy layer may not be sufficiently spread to a base material during transition liquid phase bonding and it may be problematic in terms of economy.

Since the composition of the alloy layer, and the thickness and formation of the plate in the method of manufacturing a plate are similar to those in the above plate according to the present disclosure, detailed description thereof will be omitted.

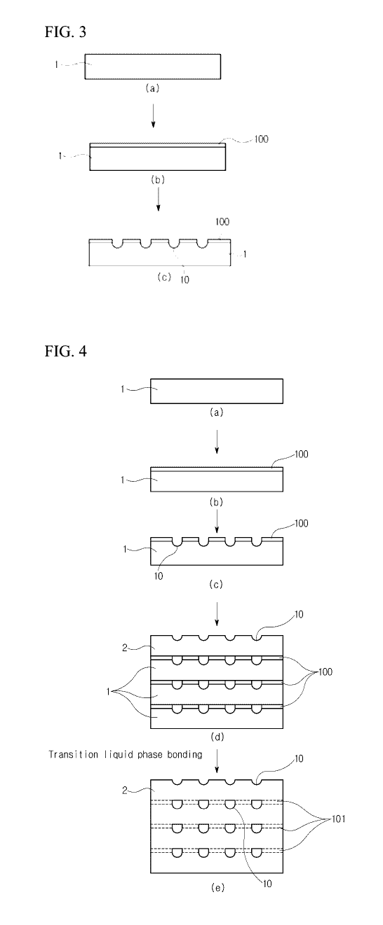

FIG. 3 is a flowchart schematically illustrating a process of manufacturing a heat exchanger plate according to an embodiment of the present disclosure. After a plate 1 is first prepared (a), an alloy layer 100 is formed on one surface of the plate 1 (b), and passages 10 are formed on the surface formed with the alloy layer 100 (c).

Alternatively, the present disclosure provides a heat exchanger including two or more plates. In the heat exchanger, the two or more plates are laminated in the state in which an alloy layer is interposed between one plate and another plate, and the alloy layer forms a bonding portion by transition liquid phase bonding.

Specifically, when two or more plates, each having an alloy layer formed thereon, are laminated in the state in which the alloy layer is interposed between the two plates, the alloy layer may form a plate bonding portion by transition liquid phase bonding. That is, when a melting point depression element such as B, Si, or P contained in the alloy layer is spread to a plate base material during the transition liquid phase bonding, the melting point of the alloy layer is increased so that the bonding portion may be formed by generation of isothermal solidification.

In the present disclosure, the alloy layer may be formed by electroless plating or thermal spray coating.

In addition, although the thickness of the alloy layer is not especially limited, the alloy layer preferably has a thickness of 30 to 100 μm. When the alloy layer has a thickness less than 30 μm, it may be difficult to sufficiently form a bonding portion. When the alloy layer has a thickness greater than 100 μm, the alloy layer may not be sufficiently spread to the base material for transition liquid phase bonding and it may be problematic in terms of economy.

In the present disclosure, the composition of the alloy layer includes at least one of elements such as B, Si, and P which may depress the melting point of the plate base material, and may further include Cr and/or Ni as occasional demands in order to improve corrosion resistance and oxidation resistance. However, the present disclosure is not limited thereto.

In addition, the specific composition of the alloy layer may be properly adjusted according to materials of the plate in the present disclosure. When the plate is made of an STS material or a nickel alloy in the present disclosure, the alloy layer may preferably include 5 to 25% by weight of Cr, more than 0 to 10% by weight of Si, more than 0 to 5% by weight of Al, more than 0 to 5% by weight of Ti, 0.5 to 4% by weight of B, and a balance of Ni. More preferably, the alloy layer may include 5 to 20% by weight of Cr, more than 0 to 5% by weight of Si, more than 0 to 5% by weight of Al, more than 0 to 5% by weight of Ti, 0.5 to 4% by weight of B, and a balance of Ni. In another example, the alloy layer may include 1 to 5% by weight of B and 95 to 99% by weight of Ni. In a further example, the alloy layer may include 1 to 13% by weight of P and 87 to 99% by weight of Ni, and more preferably may include 1 to 10% by weight of P and 90 to 99% by weight of Ni.

Here, the specific composition of the STS plate is not especially limited. For example, STS 316L or STS 304 may be used as the material of the plate.

The specific composition of the nickel-alloy plate is not especially limited.

For example, an inconel 617 plate or a hayness 230 plate may be used as the plate.

When the plate is made of an aluminum alloy in the present invention, the alloy layer may preferably include more than 0 to 15% by weight of Si, more than 0 to 2% by weight of Mg, and a balance of Al.

Meanwhile, at least one surface of the plate according to the present disclosure may be formed with a passage in which heat exchange may be performed while a refrigerant flows in the passage. The shape of the passage is not especially limited in the present disclosure. For example, the passage may have a zigzag shape. In this case, the alloy layer of the present disclosure may be formed on a surface in which the passage is formed, or may be formed on a different surface in which the passage is not formed. Here, when the alloy layer is formed on the surface in which the passage is formed, the alloy layer is formed only in a portion except for the passage.

In addition, the thickness of the plate is not especially limited in the present disclosure, and it may be selected according to devices to which a heat exchanger is applied or components thereof. However, the plate preferably has a thickness of 0.05 to 0.15 mm in consideration of heat exchanger efficiency and economy.

In an embodiment, the present disclosure provides a method of manufacturing a heat exchanger including a step of preparing two or more plates, a step of forming an alloy layer including at least one of melting point depression elements such as B, Si, and P such that the alloy layer may be bonded to a second plate by transition liquid phase bonding on at least one surface of the plate, a step of laminating the two or more plates, each having the alloy layer formed thereon, and a step of performing bonding heat treatment on the laminated plates under the conditions of a degree of vacuum of 1×10⁻⁴ to 1×10⁻³ torr and a temperature of 900 to 1200° C. for 0.1 to 6 hours.

The present disclosure may first perform the step of preparing two or more plates. The thickness of each of the plates is not especially limited, and it may be selected according to devices to which a heat exchanger is applied or components thereof. However, the plate preferably has a thickness of 0.05 to 0.15 mm in consideration of heat exchanger efficiency and economy.

When the two or more plates are prepared, to step of forming an alloy layer on at least one surface of each of the plates may be performed. The alloy layer is formed by electroless plating or thermal spray coating.

Specifically, the electroless plating may be performed by depositing at least one surface of the plate into a plating solution which includes an alloy composition having at least one melting point depression element of B and P, and a reducing agent.

Here, the type of the reducing agent is not especially limited. For example, the reducing agent may be at least one selected from the group consisting of formaldehyde (HCHO), glyoxylic acid made based on glycerin, sodium hypophosphite (NaPO₂H₂.H₂O), boron hydride, and dimethylamine-boron (DMAB).

In addition, the thermal spray coating may be performed by spraying an alloy composition having at least one melting point depression element of B and P onto at least one surface of the plate using a plasma gun or the like.

Meanwhile, at least one surface of the plate used in the present disclosure may be formed with a passage in which heat exchange may be performed while a liquid or gas phase fluid used as refrigerant flows in the passage. The process of forming the passage is not especially limited, and may be performed by typical methods known to those skilled in the art. For example, various passages may be formed on the plate by machining or chemical etching.

The process of forming the passage may be performed before or after the step of forming an alloy layer, but the present disclosure is not limited thereto.

However, when the alloy layer is formed on the surface of the plate in which the passage is formed in an embodiment, it is preferable that the passage is formed after forming the alloy layer by electroless plating or thermal spray coating, or after the passage is formed, the alloy layer is formed by thermal spray coating only in a portion in which the passage is not formed.

In addition, when the alloy layer is formed on the surface of the plate in which the passage is not formed in another embodiment, the process of forming the passage may be selectively performed before or after the step of forming an alloy layer according to conditions for performing the process.

The step of forming an alloy layer in the present invention is preferably performed such that the alloy layer has a thickness of 30 to 100 μm. When the alloy layer has a thickness less than 30 μm, it may be difficult to sufficiently form a bonding portion. When the alloy layer has a thickness greater than 100 μm, the alloy layer may not be sufficiently spread to a base material during transition liquid phase bonding and it may be problematic in terms of economy.

When the plates, each having the alloy layer formed thereon, are prepared, the step of laminating the two or more plates may be performed to form a plate laminate. In this case, the two or more plates may be laminated such that the alloy layer is interposed between one plate and another plate.

In addition, a plate which is not formed with an alloy layer may be additionally laminated on the uppermost layer or lowermost layer of the plate laminate.

The present disclsoure may then perform a transition liquid phase bonding process including a step of performing bonding heat treatment by heating and maintaining the laminated plates under the conditions of a degree of vacuum of 1×10⁻⁴ to 1×10⁻³ torr and a temperature of 900 to 1200° C. for 0.1 to 6 hours, and slowly cooling the laminated plates to a temperature of 20 to 25° C. Since a melting point depression element such as B, Si, or P contained in the alloy layer is spread to a plate base material when the bonding heat treatment is performed, the melting point of the alloy layer is increased so that an isothermal bonding portion may be formed.

Since blow holes or precipitates are not formed in the bonding portion formed in the present disclosure by the transition liquid phase bonding process, the plate can have a high boning quality. In addition, since there is no need for the conditions of a high degree of vacuum and a high-temperature environment for bonding, the process can be easily and economically employed and it is possible to increases production efficiency.

Since the composition of the alloy layer and the formation of the plate in the method of manufacturing a heat exchanger are similar to those in the above heat exchanger according to the present invention, detailed description thereof will be omitted.

FIG. 4 is a flowchart schematically illustrating a process of manufacturing a heat exchanger plate according to an embodiment of the present disclosure. The heat exchanger is manufactured in such a manner that, after a plate 1 is first prepared (a), an alloy layer 100 is formed on one surface of the plate 1 (b), passages 10 are formed on the surface formed with the alloy layer 100 (c), three plates are laminated such that an alloy layer 100 is interposed between two plates 1, a plate 2 which is not formed with an alloy layer is laminated on the uppermost layer to for a plate laminate (d), and the alloy layer 100 forms a bonding portion 101 by transition liquid phase bonding.

Hereinafter, the present disclosure will be described in more detail through specific embodiments. The following embodiments are given by way of examples for the understanding of the present disclosure, and the present disclosure is not limited thereto.

### EMBODIMENTS

### Manufacturing Example 1

After an STS 316L plate is prepared, an alloy layer is formed by immersing one surface of the plate into a plating solution which includes an alloy composition composed of 10% by weight of P and 90% by weight of Ni, and a reducing agent of sodium hypophosphite (NaPO₂H₂.H₂O).

### Manufacturing Example 2

### Ni-Based Plate

After a haynes 230 plate is prepared, an alloy layer is formed by immersing one surface of the plate in a plating solution which includes an alloy composition composed of 3% by weight of B and 97% by weight of Ni, and a reducing agent of sodium hypophosphite (NaPO₂H₂ H₂O).

### Manufacturing Example 3

### Al-Based Plate

After an incoloy 800H plate is prepared, an alloy layer is formed by performing thermal spray coating on an alloy composition composed of 12% by weight of Si, 1.5% by weight of Mg, and a balance of Al using a plasma gun of FIG. 2. Here, nitrogen gas is used as plasma gas in the thermal spray coating.

### Examples 1 to 3

After a plate which is not formed with an alloy layer is laminated on the alloy layer manufactured in the manufacturing examples 1 to 3, a plate laminate is manufactured by performing bonding heat treatment on the laminated plate by heating and maintaining the same under the conditions of a degree of vacuum of 3×10⁻⁴ torr and a temperature of 1,050 to 1,100° C. for one hour, and then by slowly cooling the same to a room temperature.

### Comparative Example 1

After two plates having an STS 316L material are prepared, a plate laminate is manufactured by inserting an aluminum filler alloy, which is composed of 6% by weight of Si, 4% by weight of Zn, 0.5% by weight of Cu, and a balance of Al, between the two plates and by brazing the same at a temperature of 600° C. for 10 minutes in nitrogen atmosphere.

### Comparative Example 2

After two Haynes 230 plates are prepared, a plate laminate is manufactured by bonding the two plates at a temperature of 1150° C. and a pressure of 4 MPa for 4 hours through the contact thereof, and then by performing post heat treatment on the same at a temperature of 1200° C. for 100 hours.

### Experimental Example 1

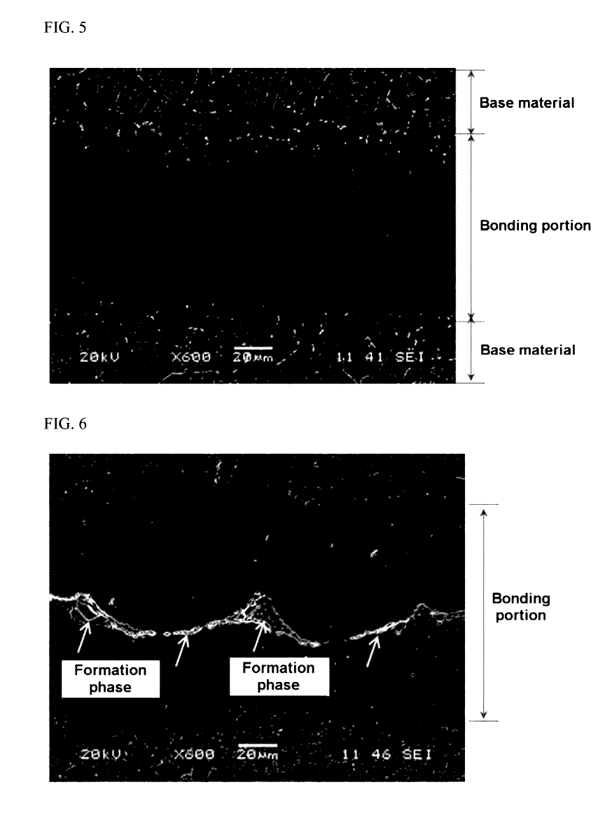

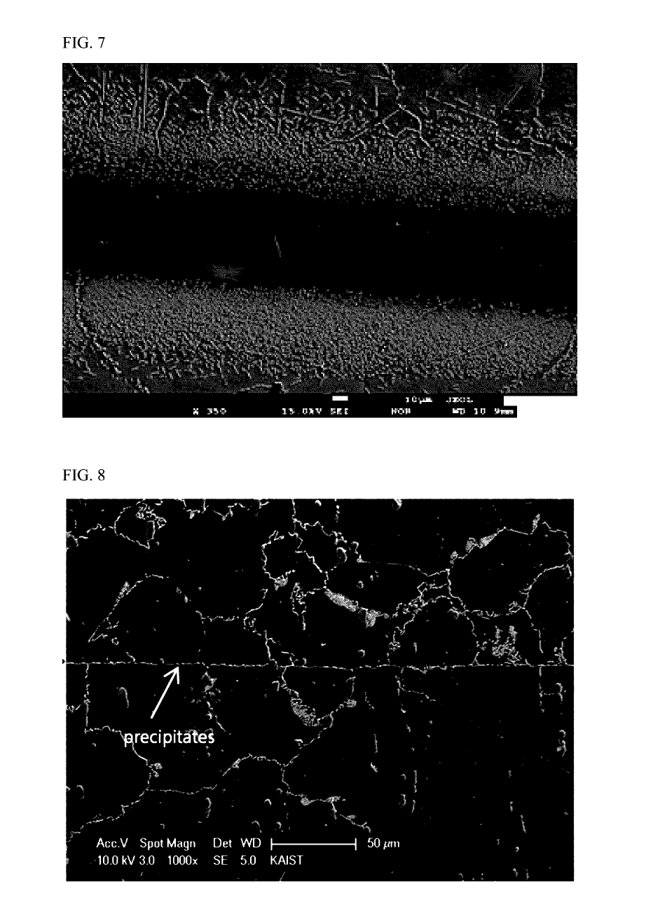

FIGS. 5 and 6 illustrate respective photographs obtained by observing the bonding portions of the plate laminates manufactured in the example 1 and comparative example 1 using an electron microscope (SEM).

As illustrated in FIG. 5, it may be seen that the two plates are bonded without particular separation in the bonding portion of the plate laminate according to the present disclosure, and any formation phase or defect does not occur in the bonding portion.

On the other hand, as illustrated in FIG. 6, when two plates are bonded by brazing, it may be seen that various formation phases are formed in line in the bonding portion. The formation phases may have an adverse influence on mechanical physical properties of the bonding portion.

### Experimental Example 2

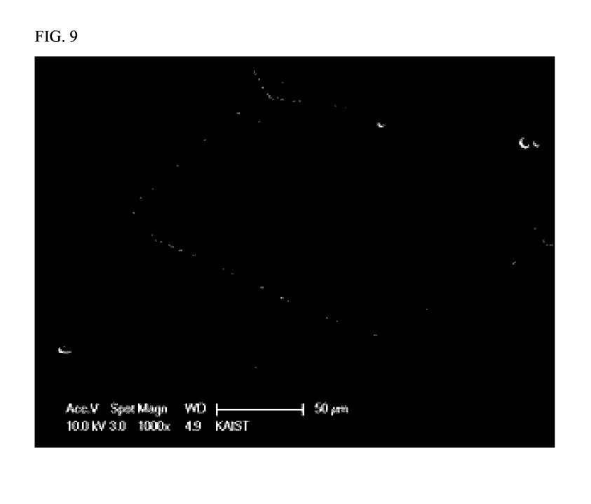

FIGS. 7 to 9 illustrate respective photographs obtained by observing the bonding portions of the plate laminates manufactured in the example 2 and comparative example 2 using an electron microscope (SEM).

As illustrated in FIG. 7, it may be seen that the two plates are bonded without particular separation in the bonding portion of the plate laminate according to the present disclosure, and any formation phase or defect does not occur in the bonding portion.

On the other hand, as illustrated in FIG. 8, when two plates are bonded by solid phase bonding, it may be seen that various formation phases are formed in the bonding portion before post heat treatment. Since precipitates are formed in line which may lead to poor bonding, they may have an adverse influence on mechanical physical properties.

Accordingly, post heat treatment may be performed at a temperature of 1200° C. for 100 hours in order to remove defects due to the solid phase bonding from the bonding portion. However, since a high-temperature environment and a long processing time are required for the post heat treatment, production efficiency may be deteriorated.

As is apparent from the above description, a heat exchanger plate according to the present disclosure can allow another plate or other components such as a refrigerant pipe to be easily bonded by transition liquid phase bonding.

Since a plurality of plates are bonded by transition liquid phase bonding in a heat exchanger according to the present disclosure, a good bonding portion is formed without defects therein, thereby enabling the heat exchanger to have a high quality.

Since a method of bonding a heat exchanger plate according to the present disclosure does not require the conditions of a high degree of vacuum and a high pressure as in conventional solid phase bonding, it is possible to reduce costs for manufacturing equipment, easily employ a bonding condition, and more improve production efficiency.

Since the method of bonding a heat exchanger plate according to the present disclosure is performed for a short time, it is possible to suppress growth of crystal grains, and to thereby prevent deterioration of physical properties.

Since the method of bonding a heat exchanger plate according to the present disclosure does not require separate post heat treatment as in conventional solid phase bonding, it is possible to reduce production costs and times, and to thereby improve production efficiency.

The embodiments discussed have been presented by way of example only and not limitation. Thus, the breadth and scope of the invention(s) should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A heat exchanger plate comprising:
a plate; and
an alloy layer bonded to a bonding object by transition liquid phase bonding on at least one surface of the plate, wherein
the alloy layer comprises at least one melting point depression element such as B, Si, and P.

2. The heat exchanger plate according to claim 1, wherein a passage operable to flow liquid or gas is defined in the at least one surface of the plate.

3. The heat exchanger plate according to claim 1, wherein the plate is selected from the group consisting of an STS plate, a Ni-alloy plate, and an Al-alloy plate.

4. The heat exchanger plate according to claim 1, wherein the alloy layer has a thickness in the range of 30 to 100 μm.

5. The heat exchanger plate according to claim 1, wherein the alloy layer comprises 5 to 25% by weight of Cr, greater than 0% to less than or equal to 10% by weight of Si, greater than 0% to less than or equal to 5% by weight of Al, greater than 0% to less than or equal to 5% by weight of Ti, 0.5 to 4% by weight of B, and a balance of Ni.

6. The heat exchanger plate according to claim 1, wherein the alloy layer comprises 1 to 5% by weight of B and 95 to 99% by weight of Ni.

7. The heat exchanger plate according to claim 1, wherein the alloy layer comprises 1 to 13% by weight of P and 87 to 99% by weight of Ni.

8. The heat exchanger plate according to claim 1, wherein the alloy layer comprises greater than 0% to less than or equal to 15% by weight of Si, greater than 0% to less than or equal to 2% by weight of Mg, and a balance of Al.

9. The heat exchanger plate according to claim 1, wherein the alloy layer is formed by electroless plating or thermal spray coating.

10. A heat exchanger, comprising:
two or more of an STS plate, a Ni-alloy plate, and an Al-alloy plate; and
an alloy layer bonded to a bonding object by transition liquid phase bonding on at least one surface of each of the plates, wherein
a passage operable to flow a liquid or gas is defined in the at least one surface of the plate,
the alloy layer includes at least one melting point depression element such as B, Si, and P,
the alloy layer is formed by electroless plating or thermal spray coating,
the two or more plates are laminated in a state in which the alloy layer is interposed between the respective plates, and
the alloy layer forms a bonding portion by the transition liquid phase bonding.

11. The heat exchanger according to claim 10, wherein the alloy layer comprises 5 to 25% by weight of Cr, greater than 0% to less than or equal to 10% by weight of Si, greater than 0% to less than or equal to 5% by weight of Al, greater than 0% to less than or equal to 5% by weight of Ti, 0.5 to 4% by weight of B, and a balance of Ni.

12. The heat exchanger according to claim 10, wherein the alloy layer comprises 1 to 5% by weight of B and 95 to 99% by weight of Ni.

13. The heat exchanger according to claim 10, wherein the alloy layer comprises 1 to 13% by weight of P and 87 to 99% by weight of Ni.

14. The heat exchanger according to claim 10, wherein the alloy layer comprises greater than 0% to less than or equal to 15% by weight of Si, greater than 0% to less than or equal to 2% by weight of Mg, and a balance of Al.

15. A method of manufacturing a heat exchanger, comprising:
preparing two or more plates;
forming an alloy layer comprising at least one of melting point depression element such as B, Si, and P such that the alloy layer is bonded to a second plate by transition liquid phase bonding on at least one surface of each of the plates;
laminating the two or more plates, each having the alloy layer formed thereon; and
performing bonding heat treatment by heating and maintaining the laminated plates under conditions of a degree of vacuum in the range of of 1×10⁻⁴ to 1×10⁻³ ton and a temperature in the range of 900 to 1200° C. for 0.1 to 6 hours.

16. The method according to claim 15, wherein the forming an alloy layer is performed by electroless plating or thermal spray coating.

17. The method according to claim 15, wherein the forming an alloy layer is performed such that the alloy layer has a thickness of 30 to 100 μm.

18. The method according to claim 16, further comprising, after forming the alloy layer by the electroless plating or thermal spray coating, forming a passage operable to flow a liquid or gas in each of the plates.

19. The method according to claim 16, further comprising, before forming the alloy layer by the thermal spray coating, forming a passage operable to flow a liquid or gas in each of the plates.

20. The method according to claim 15, wherein, in the laminating the two or more plates, the two or more plates are laminated such that the alloy layer is interposed between the respective plates.
